(19) United States
(12) Patent Application Publication
(10) Pub. No.: US 2010/0183152 A1
(43) Pub. Date: Jul. 22, 2010

(54) NETWORK AND METHOD FOR INITIALIZING A TRUST CENTER LINK KEY

(75) Inventors: Axel Gunther Hubner, Munchen (DE); Pehr Soederman, Solna (SE); Oscar Garcia Morchon, Aachen (DE); Heribert Baldus, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/666,835

(22) PCT Filed: Jun. 26, 2008
(86) PCT No.: PCT/IB08/52568

§ 371 Date: Dec. 28, 2009

(30) Foreign Application Priority Data
Jul. 4, 2007 (EP) 07111767.5

(51) Int. Cl. H04W 12/04; H04L 9/08

(52) U.S. Cl. 380/270; 380/279; 380/44

(57) ABSTRACT

The invention relates in general to a network and to a method for initializing a trust center link key. According to an embodiment of the invention, a network is provided with a new node (106) comprising node specific cryptographic keying material, wherein the new node is configured to specify an cryptographic key based on the node specific cryptographic keying material, a first node (102) requiring the cryptographic key for a network security initialization and means (108) for providing a missing cryptographic key to the first node from a storage different to the new node, wherein the missing cryptographic key is equal to the cryptographic key.

The invention relates in general to a network and to a method for initializing a trust center link key.

Wireless sensor networks (WSNs) have gained in importance for home monitoring and control, like lighting applications. For such applications, security methods protecting users' confidentiality are of special interest. While typically a wide range of security services are offered in existing standards, such as, for instance, ZigBee®: ZigBee Alliance; ZigBee® Specification. December 2006, the secure initialization of cryptographic keys is still unsolved.

The secure management, especially the secure initialization, of cryptographic keys is of essential importance for wireless sensor networks security. The initialization of cryptographic symmetric keys represents a procedure that results in a shared secret between two devices. This shared secret allows setting up another cryptographic key between these devices in a secure manner, and hence establishing secure communication between two devices.

In the relevant standards, such as ZigBee®, the initialization of such shared secrets, the so-called master keys, is not sufficiently covered, even though security services are defined that rely on the availability of master keys. Only two cases are considered in the ZigBee® specification, the pre-programming and the plain-text transmission of master keys. The pre-programming mechanism is only applicable, if it is known during manufacture which sensor node will belong to a certain network. This may not be the case for commercial products, where the user shall be able to simply buy a node in a shop and add it to his network. The plain-text transmission of master keys, i.e., the second mechanism considered in ZigBee®, should be avoided, since it allows an easy attack on the network.

WO 2006/131849 is directed to a wireless network for monitoring a patient, comprising a body sensor network including wireless sensors, a set-up server and a base station. The set-up server configures the wireless sensors before being deployed to the wireless network. The base station distributes a key certificate to the sensors such that two sensors generate a unique pair wise key, based at least in part upon the pre-distributed keying material and the key certificate distributed by the base station.

It is an object of the present invention to provide an improved network, an improved trust center and an improved method for initializing a network key.

The object is solved by the independent claims. Further embodiments are shown by the dependent claims.

A basic idea of the invention is to provide new solutions for the secure initialization of cryptographic keys of a network, like a ZigBee® wireless sensor network, which may be based on an easy-to-use automated procedure, where a user only once has to authenticate upon request.

One solution would be to pre-configure all sensor nodes with the same keying material during manufacture. However, since commercial applications, such as home monitoring and control including lighting applications, are considered here, this solution may be not feasible due to the following reason. Letting all sensor nodes be preconfigured with the same keying material during manufacturing process would allow an attacker to simply buy a sensor node in a shop and use it to compromise the wireless sensor network of a user without any effort.

Using key pre-distribution schemes, as described in “Key distribution mechanisms for wireless sensor networks: a survey” by S. A. Camtepe et al, Rensselaer polytechnic” leads to a similar problem, since for commercial products it may be not possible to specify in advance the network a sensor node will belong to. Hence, during manufacture all sensor nodes would need to be preconfigured with keying material that would enable each pair of nodes to agree on one cryptographic key, resulting in a situation comparable to the case where all sensor nodes would obtain the same keying material, and thus the same attack would be possible.

Another solution would be to let all sensor nodes be uninitialized and leave it to the user to perform the initialization by hand. However, this may not represent an easy-to-use solution, at least not from a user's perspective, since the user would need to configure all nodes prior to deployment.

A system according to the invention represents an easy-to-use solution for a secure key initialization in wireless sensor networks. Such wireless sensor networks may be ZigBee® commercial applications such as, home monitoring and control including lighting applications. Initial keying material, like master keys stored in one sensor node may be easily loaded to another sensor node, such as, for instance, a trust center of a ZigBee® based wireless sensor network, without requiring a user to have detailed knowledge of the underlying security mechanisms. Only a few very easy steps need to be carried out to securely initialize keying material allowing further security mechanisms like the secure establishment of trust center link keys, and thus the secure exchange of a network key.

The inventive solutions for the secure initialization of cryptographic keys of a network satisfy major security requirements.

In particular, initial keying material, like a master key may be sensor node specific in order to avoid the possibility of an easy-to-perform attack on the privacy of the user running the wireless sensor network.

Further, security breaks of the initial keying material are identifiable. The user may be able to check whether the initial keying material has been broken prior to deployment of the respective sensor node.

A procedure for key initialization to be performed by the user is easy to use, in order to avoid security breaks caused by wrong usage. To be more specific, the complexity may be restricted to simply entering one character string once per device.

In addition, the initialization procedure is robust against attacks during the period of time required for the initialization procedure and allows secure reconfiguration of the network.

According to an embodiment of the invention, a network is provided which comprises:

a new node comprising node specific cryptographic keying material, wherein the new node is configured to specify a cryptographic key based on the node specific cryptographic keying material;

a first node requiring the cryptographic key for a network security initialization; and

means for providing a missing cryptographic key to the first node from a storage different to the new node, wherein the missing cryptographic key is equal to the cryptographic key.

As the missing cryptographic key is stored separately from the cryptographic key, there is no need to transfer the cryptographic key from the new node to the first node via a possibly insecure link between the new node and the first node. The link between the new node and the first node is considered insecure as long as the first node has not received the cryptographic key of the new node. Storing the missing cryptographic key separately from the cryptographic key allows the first node to receive the cryptographic key via a secure link. Despite the different storage location, the cryptographic key and the missing cryptographic key may be identical.

The cryptographic keying material may be stored in the new node before the new node is connected to the network. Thus, the cryptographic keying material can be stored in the new node while the new node is located in a secure environment which prevents an attacker to get knowledge of the cryptographic keying material during a transfer of the cryptographic keying material into the new node.

The new node may be configured to specify the cryptographic key after being connected to the network or after a reconfiguration of the network. In case that the new node is able to choose between a plurality of different cryptographic keys, the specification of the cryptographic key allows the new node to define which one of the possible cryptographic keys shall be used in the network.

A cryptographic function may be implemented in the new node and the new node may be configured to calculate the cryptographic key from the node specific cryptographic keying material using the cryptographic function. This allows the new node to calculate different cryptographic keys. This allows the new node to specify a new cryptographic key in case secrecy of a current cryptographic key can not be guaranteed any more.

The first node may be configured to detect a presence of the new node and may be configured to request the cryptographic key after having detected the presence of the new node. This allows a quick and automatic integration of the new node into the network.

The means for providing may comprise a user interface which allows a user to input the missing cryptographic key. This allows an uncomplicated and inexpensive providing of the missing cryptographic key. For example, the missing cryptographic key may be stored on a tamper-proof sticker which is provided to the user. The user may provide the missing cryptographic key from the tamper-proof sticker to the first node via the user interface. Accordingly, a sensor network key initialization may be performed in the network without requiring a secure server and corresponding network infrastructure

Alternatively, the storage may be a secure server comprising cryptographic keying material corresponding to the new node and the means for providing may be configured to download the missing cryptographic key from the secure server. This allows storing the missing cryptographic key in a secure place like a server being operated by a manufacturer of the new node.

The secure server may be configured to calculate the missing cryptographic key from the cryptographic keying material corresponding to the new node. In case the new node is capable of calculating different cryptographic keys, the secure server may calculate the same cryptographic keys based on the same cryptographic keying material.

The cryptographic keying material corresponding to the new node may be stored in the secure server before the new node is connected to the network. This allows storing the cryptographic keying material corresponding to the new node at a time an attention of an attacker is not evoked due to the connection of the new node into the network. For example, the cryptographic keying material corresponding to the new node may be stored in the secure server while the new node is manufactured.

The means for providing may comprise an authentification interface which allows a user to input authentification data being necessary for providing the missing cryptographic key. Thus, the missing cryptographic key may only be requested, calculated or provided after a user authentification. This prevents an attacker not having access to the authentification data to successfully perform a network key initialization.

The authenfication data may be specific to the new node. This prevents an attacker to use previous authenfication data to perform a network key initialization for the new node.

The new node may be capable of calculating different cryptographic keys each being characterized by a key index and the new node may be configured to provide a key index characterising the associated key to the first node and the first node may be configured to request the cryptographic key characterized by the key index after having received the key index. This allows the new node to declare which one of a plurality of different cryptographic keys is specified as the cryptographic keys. Further, the index allows the user or the secure server to provide the correct cryptographic key to the first node.

The network may be a wireless sensor network and the new node may be a sensor of the wireless sensor network. In particular, the network may be a ZigBee® based wireless sensor network such as a wireless sensor network lighting system, a wireless sensor network home monitoring and control system or a wireless sensor network personal healthcare and wellness system.

According to a further embodiment of the invention, a trust center suitable for a network security initialization is provided which comprises:

means for detecting a presence of a new node in the network, wherein the new node comprises an cryptographic key;

means for requesting the cryptographic key; and

means for receiving a missing cryptographic key from a device different to the new node, wherein the missing cryptographic key is equal to the cryptographic key.

The trust center may be used as the first node in an inventive network. Thus, the trust center allows a secure network key initialization when a new node is connected to the network or the network is reconfigured.

According to a further embodiment of the invention, a method for initializing a network key is provided which comprises the steps of:

specifing a cryptographic key by a new node of a network, based on a node specific cryptographic keying material;

requesting the cryptographic key by a first node of the network;

providing a missing cryptographic key to the first node from a storage different to the new node, wherein the missing cryptographic key is equal to the cryptographic key.

The method for initializing a network key can be advantageously performed in connection with an inventive network when a new node is connected to the network or the network is reconfigured.

According to an embodiment of the invention, a computer program may be provided, which is enabled to carry out the above method according to the invention when executed by a computer. This allows realizing the inventive approach in a compiler program.

According to a further embodiment of the invention, a record carrier storing a computer program according to the invention may be provided, for example a CD-ROM, a DVD, a memory card, a diskette, or a similar data carrier suitable to store the computer program for electronic access.

These and other aspects of the invention will be apparent from and elucidated with reference to the embodiments described hereinafter.

The invention will be described in more detail hereinafter with reference to exemplary embodiments. However, the invention is not limited to these exemplary embodiments.

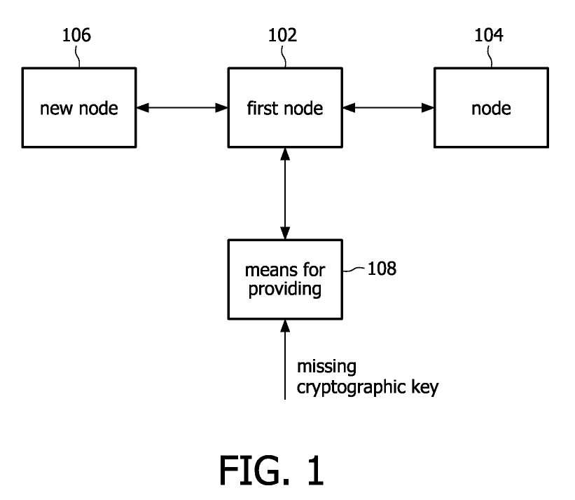

FIG. 1 shows a network according to the invention;

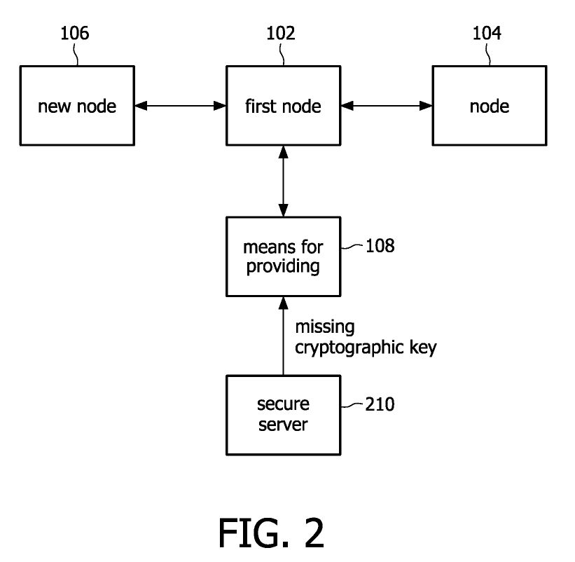

FIG. 2 shows a further network according to the invention;

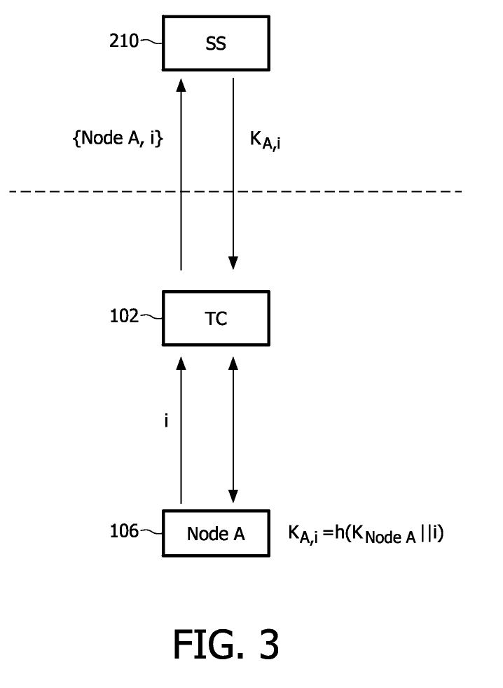

FIG. 3 shows a further network according to the invention; and

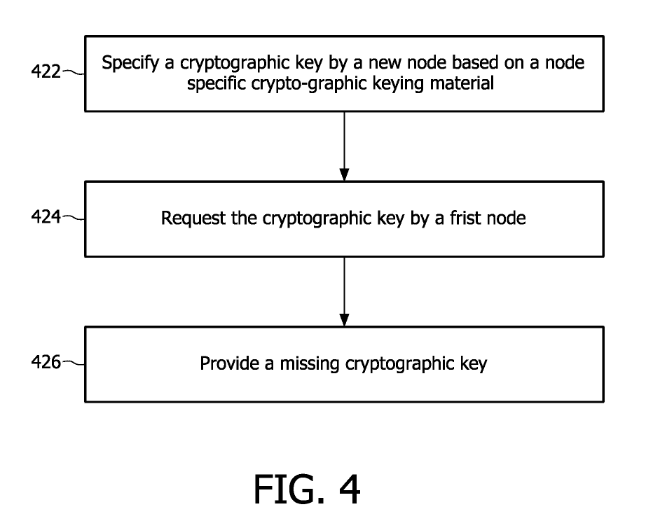

FIG. 4 shows a flow diagram of a method according to the invention.

In the following, functional similar or identical elements may have the same reference numerals.

FIGS. 1 and 2 show similar networks according to different embodiments of the invention. According to the embodiment shown in FIG. 1, a missing cryptographic key may be provided to the network by a user via a user interface. According to the embodiment shown in FIG. 2 the missing cryptographic key may be provided to the network by a secure server. FIG. 3 depicts a key initialization in a network in which the missing cryptographic key is provided by a secure server as shown in FIG. 2.

FIG. 1 shows a network according to an embodiment of the invention. The network comprises a first node 102, a node 104, a new node 106 and means for providing 108. The nodes 102, 104, 106 and the means for providing 108 may be connected via a communication infrastructure and may comprise suitable communication means. The network may comprise further nodes.

The network may be a wireless sensor network like a ZigBee® based

WSN lighting system, a WSN home monitoring and control system or a WSN personal healthcare and wellness system. Accordingly, the nodes 102, 104, 106 may be sensors. The nodes 102, 104, 106 may comprise cryptographic keys. The first node 102 may be a trust center of the network. The trust center 102 may collect cryptographic keys belonging to the nodes 104, 106 of the network. The cryptographic keys may be master keys required for establishing secure communication links within the network.

One of the services relying on the availability of the master keys is the establishment of trust center link keys by using the symmetric key key exchange (SKKE) protocol. The trust center link keys may be used for a secure exchange of a network key. Hence, without the secure initialization of cryptographic keys, being shared secrets or master keys, the secure exchange of a network key is not possible.

The new node 106 comprises node specific cryptographic keying material. The cryptographic keying material may be stored in the new node before the new node is connected to the network, for example during manufacture of the new node. According to an embodiment the node specific cryptographic keying material comprises one or more cryptographic keys which are assigned to and are specific to the new node 106. According to an alternative embodiment, the cryptographic keying material may comprise cryptographic data which allows deriving one or more cryptographic keys which are assigned to and are specific to the new node 106. For example, the cryptographic keying material may further comprise a cryptographic function allowing the new node to calculate one or more cryptographic keys from the cryptographic keying material by using the cryptographic function.

The new node 106 may specify its cryptographic key after being connected to the network or after a reconfiguration of the network. Depending on the type of the cryptographic keying material, the new node 106 may comprise means for selecting the cryptographic key from the cryptographic keying material or means for calculating the cryptographic key from the cryptographic keying material

The first node 102 may require the cryptographic keys of the node 104 and the node 106 for a network security initialization which may be necessary for a secure operation of the network. The first node 102 may comprise storage means for storing the cryptographic keys of the node 104 and the new node 106. In case the first node 102 does not comprise a required cryptographic key of one of the nodes 104, 106 connected to the network, the respective missing cryptographic key has to be made available for the first node 102. The first node 102 may comprise means for requesting a missing cryptographic key and means for receiving the requested cryptographic key. The first node 102 may comprise means for detecting a presence of the new node 106 after its connection to the network which allows the first node 102 to request the missing cryptographic key immediately or soon after the connection of the new node 106 to the network.

The cryptographic key, for example the cryptographic key of the new node 106, is additionally stored or deposited at a secure place, for example in a security device which is not the new node. The cryptographic key and the separately stored cryptographic key, referred to as the missing cryptographic key, form a pair of cryptographic keys. According to this embodiment, both cryptographic keys are identical. There may be cryptographic keys requiring a pair of different cryptographic keys.

The missing cryptographic key may be provided to the first node 102 via the means for providing 108. According to this embodiment, a user of the network has access to the missing cryptographic key. In order to provide the missing cryptographic key to the first node 102, the means for providing 108 may comprise a user interface which allows the user to input the missing cryptographic key. The means for providing 108 may be integrated in one of the network nodes, may be a special network node or may be a device connected to the network only for allowing the user to input the cryptographic key. According to this embodiment, the means for providing may be a computer connected to the network.

According to a further embodiment, the new node 106 is a sensor node of a wireless sensor network, the first node 102 is a trust center of the network and the means for providing 108 is a customer tool. The sensor node specific cryptographic key is stored on the sensor node 106 during manufacture. In addition, the sensor node specific cryptographic key is printed on a tamper-proof sticker that is provided with the sensor node 106 itself When the sensor node 106 is brought into the wireless sensor network, the trust center 102 initializes a procedure requesting the master key of the sensor node 106. In this case, using a network infrastructure and the customer tool 108, a window may pop up at the customer tool 108 requesting the sensor node specific cryptographic key from the user. The user may break the tamper-proof sticker and may enter the sensor node specific cryptographic key which is then stored on the trust center 102. When the association procedure is successfully finished, the user may be notified. The solution described in the embodiments is well suited not only for

ZigBee® based wireless sensor networks but for all networks and specifically for all wireless sensor networks relying on a trust center and shared secrets.

FIG. 2 shows a network according to a further embodiment of the invention. The network corresponds to the network described in FIG. 1. In difference to the network described in FIG. 1, the missing cryptographic key is not provided via a user interface of the means for providing 108 but from a secure server 210.

The secure server 210 may comprise cryptographic keying material corresponding to the cryptographic keying material of the nodes 104, 106 of the network. According to this embodiment, the secure server 210, in particular, comprises cryptographic keying material corresponding to the new node 106. The cryptographic keying material may be stored in the secure server before the new node is connected to the network. The secure server 210 may be configured to calculate the missing cryptographic key, for example the missing cryptographic key corresponding to the new node 106, from the cryptographic keying material corresponding in order to provide the missing cryptographic key. The secure server 210 may be configured to provide the missing cryptographic key via the means for providing 108 to the first node 102. For example, the means for providing 108 may be configured to download the missing key from the secure server 210. Alternatively, the secure server 210 may provide the missing cryptographic key directly to the first node 102.

The means for providing 108 may comprise an authentification interface which allows a user to input authentification data which may be necessary for providing the missing cryptographic key. The authenfication data may be specific to the node whose cryptographic key is requested from the secure server 210.

According to a further embodiment the network is a, e.g. ZigBee® based, wireless sensor network. The new node 106 is a sensor node 106 to be securely brought into the wireless sensor network. The first node 102 is another node of the wireless sensor network acting as a coordinator and trust center of the wireless sensor network. The network further comprises a sensor node infrastructure, i.e. an interface the sensor node 102 acting as coordinator is attached to. Further, the wireless sensor network comprises the secure server 210. The means for providing 108 is a customer tool. The customer tool 108 may be a device capable to run a small application program, such as a workstation, a laptop, or the like, and to connect to a network infrastructure. The network infrastructure may enable the user to connect to the secure server 210. The network may further comprise protocols for the communication between the customer tool 108 and the sensor node 102 acting as a coordinator, user authentication material and a tamper-proof device, e.g. a tamper-proof sticker.

An initialization of cryptographic keys for the network may include that, during manufacture of the sensor node 106, sensor node specific cryptographic keying material, being secret, is stored in a memory of the sensor node 106. Additionally, a cryptographic function is implemented on the sensor node 106.

The same cryptographic keying material and a cryptographic function are stored and implemented, respectively, on the secure server 210.

User authentication material is generated for every sensor node 104, 106 and provided in a tamper-proof manner with the corresponding sensor node 104, 106.

When the new sensor node 106 is brought into the wireless sensor network for secure association, the sensor node 106 calculates a cryptographic key from its sensor node specific cryptographic keying material using the cryptographic function. A coordinator which is also the trust center 102 of the network realizes the presence of this new sensor node 106 and searches for the master key, being a shared secret, of the new sensor node 106 in its database. Since the sensor node 106 is new, no entry is found. Consequently, the coordinator 102 initializes an association procedure using the interface to the infrastructure. Automatically, the user is notified by the customer tool 108, a connection is established to the secure server 210 and user authentication is requested. Upon user authentication using the authentication material, the system firstly logs information about the key download procedure, like date, time, IP address and displays the corresponding information of the last login, thus allowing the user to detect security breaks. Due to the tamper-proof manner the authentication material is provided, the user can easily detect a security break. Then, the cryptographic key for the respective sensor node 106 is calculated using the sensor node specific cryptographic keying material and the cryptographic function stored on the secure server 210. Then, the calculated key is downloaded to the customer tool 108 and to the trust center 102 connected to the customer tool.

When the secure association has successfully been finished, an acknowledgement message is displayed on the infrastructure to notify the user.

If the network is reconfigured or when the sensor node is brought into a new network, the node 106 notices that a new trust center 102 tries to securely associate with it, and initializes a key change procedure. Using the cryptographic function, the new cryptographic key is calculated. Furthermore, a counter is used to indicate the number of key changes. Now, the senor node 106 transmits its identifier and the counter value to the trust center 102 that, since the node 106 is new to it, and thus it does not share a master key with it, initializes an initialization procedure as described. A connection to the secure server 210 is established upon user authentication. The counter value is also transmitted to the server 210 such that it can calculate the same cryptographic key and transmit it to the customer tool 108 of the user, and then to the trust center 102 of the new network. The secure association procedure is finished and the user is notified.

FIG. 3 depicts a key initialization in a network comprising a trust center 102, a sensor node 106 and a secure server 210, according to a further embodiment of the invention. The network may be the network shown in FIG. 2.

The key initialization uses the secure server 210 and the trust center 102. The sensor node 106 may be capable of calculating different cryptographic keys. Each cryptographic key may be characterized by a key index. In case the sensor node 106 specifies a new cryptographic key, the sensor node 106 may provide the key index to the trust center 102. The trust center 102 may request the cryptographic key characterized by the key index after having received the key index.

FIG. 3 depicts a communication between the sensor node 106 shown as Node A and the trust center 102, as well as a communication between the trust center 102 and the secure server 210.

In a first step the sensor node 106 calculates its association key from its sensor node specific keying material. In a second step the sensor node 106 transmits an index i of its association key to the trust center 102. In a third step the trust center 102 requests the association key for the sensor node 106 with index i from the secure server 210. In a fourth step, the secure server calculates the corresponding association key upon authentication and transmits it to the trust center 102. In a fifth step the trust center 102 receives the association key. In a six step the trust center 102 and the sensor node 106 launch a mutual authentication protocol.

In FIG. 3, KA,i denotes the cryptographic key used as a master key, i.e.

the shared secret common to the sensor node 106 and the trust center 102. The sensor node specific cryptographic keying material is called KNode A, which represents the keying material that is exclusively stored on the sensor node 106 itself and the secure server. Furthermore, h(KNode A∥i) represents a cryptographic function having the master keying material and an index i as input.

FIG. 4 shows a flow diagram of a method for initializing a network key according to an embodiment of the invention. The method may be used for a network according to embodiments of the invention.

The method assumes that during a manufacturing process of a sensor node, a sensor node specific cryptographic key is stored on a secure server and coded into the memory of the sensor node. In addition, a cryptographic function, like a hash function, is implemented on the sensor node and the secure server, respectively.

In a first step 422, the sensor node specifies a cryptographic key. In particular, when the new sensor node is brought into the network, the new sensor node calculates the cryptographic key using its sensor node specific cryptographic key and the cryptographic function.

In a second step 424, a trust center requests the cryptographic key. In particular, the trust center associated to the network notices the presence of the sensor node and starts an automated initialization protocol. It connects to a secure server, e.g. via the internet, of the sensor node provider and requests the current key assigned to the node.

In a third step 426, a missing cryptographic key is provided to the first node from a storage place different to the new sensor node. In particular, upon user authentication the secure server calculates the requested key and transmits it to the trust center that uses the shared secret for node association. For user authentication, the node comes, for instance, with login and password or personal identification number (PIN).

The proposed system also supports secure association in the case of a network reconfiguration or if the sensor node is brought into another network. To this end, the node calculates a new cryptographic key using its sensor node specific cryptographic key and the cryptographic function. Then, the node notifies the trust center of the change in its association message. The trust center requests the cryptographic key of this node from the secure server that calculates this key upon user authentication. Then, the key is transmitted to the trust center that uses it to associate or re-associate the node.

The use of the presented solutions for initialization of cryptographic keys in a network benefits from several features.

First, a sensor node specific cryptographic keying material used to calculate the master key may be stored on the corresponding sensor node during manufacture. Furthermore, a cryptographic function may be implemented on the sensor node.

The same sensor node specific cryptographic keying material used to calculate the master key may be stored on a secure server of the sensor node provider. Furthermore, a cryptographic function may be implemented on the secure server.

User authentication material, e.g., login and password or PIN, may be produced for the corresponding sensor node during manufacture. This material may be provided on a tamper-proof device, e.g., a tamper-proof sticker.

Further, an automatic protocol may support the user to securely bring a new sensor node into the network, i.e. to securely set up the shared secret. A secure connection to the server of the sensor node provider may be established upon user authentication and the cryptographic key may be transmitted in return. Furthermore, this process may be logged. Information about it, like date, time, IP address, or the like may be stored, and the corresponding information about previous key downloads may be displayed before a new key download. This allows the user to detect security breaks.

The user may need to perform the described procedure, i.e. user authentication, only once for each new sensor node.

Further, the sensor node and user authentication material can be distributed together. There is no need for additional mechanisms or procedures which makes the solution especially suited for commercial products.

The network can be reconfigured and the sensor node can be brought into a new network, respectively, without disclosure of previous symmetric cryptographic keys. Thus protecting all networks the node has been associated to.

In other words, an embodiment of the present invention offers an easy to use secure initialization of cryptographic keys in a wireless sensor network which may be used for a ZigBee® wireless sensor network security initialization. Sensor node specific cryptographic keying material used to calculate a master key is stored on a sensor node during manufacture. The same is stored on a secure server of the sensor node provider. Further a cryptographic function is implemented on the sensor node and also on the secure server. User authentication material, for example login and password or the PIN is produced for the corresponding sensor node during manufacture and is provided on a tamperproof device, such as a sticker. An automatic protocol supports the user for setup by a secure connection to the server of the sensor provider. Upon a one time user authentication the cryptographic key is transmitted in return. Further, this process is logged. Information, like date, time, IP address or the like is stored and the corresponding information about the previous key downloads is displayed before a new key download, allowing the user to detect security breaks. The network can be reconfigured and the sensor node can be brought into a new network, without disclosure of previous symmetric cryptographic keys, thus protecting all networks the node has been associated to. The key initialization may use the secure server and the trust center. An alternative approach does not require a secure server and the corresponding network infrastructure. When the sensor node is brought into the network, the trust centre initializes a procedure requesting the master key of the sensor node. The user breaks the tamper proof sticker and enters the key that is then stored on the trust center. The association completes the procedure and the user is notified.

The described embodiments may be combined. The invention is not limited to the shown networks. The inventive approach may be used in any network which requires a key initialization. The nodes may be any network nodes. The network nodes may comprise any means required by the network functionality, for example communication units or processing units.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. Network, comprising:
a new node (106) comprising node specific cryptographic keying material, wherein the new node is configured to specify a cryptographic key based on the node specific cryptographic keying material;
a first node (102) requiring the cryptographic key for a network security initialization; and
means for providing (108) a missing cryptographic key to the first node from a storage different to the new node, wherein the missing cryptographic key is equal to the cryptographic key.

2. Network according to claim 1, wherein the cryptographic keying material is stored in the new node (106) before the new node is connected to the network

3. Network according to claim 1, wherein the new node (106) is configured to specify the cryptographic key after being connected to the network or after a reconfiguration of the network.

4. Network according to claim 1, wherein a cryptographic function is implemented in the new node (106) and wherein the new node is configured to calculate the cryptographic key from the node specific cryptographic keying material using the cryptographic function.

5. Network according to claim 1, wherein the first node (102) is configured to detect a presence of the new node (106) and is configured to request the cryptographic key after having detected the presence of the new node.

6. Network according to claim 1, wherein the means for providing (108) comprises a user interface which allows a user to input the missing cryptographic key.

7. Network according to claim 1, wherein the storage is a secure server (210) comprising cryptographic keying material corresponding to the new node (106) and wherein the means for providing (108) is configured to download the missing cryptographic key from the secure server (210).

8. Network according to claim 7, wherein the secure server (210) is configured to calculate the missing cryptographic key from the cryptographic keying material corresponding to the new node (106).

9. Network according to claim 7, wherein the cryptographic keying material corresponding to the new node (106) is stored in the secure server (210) before the new node is connected to the network.

10. Network according to claim 1, wherein the means for providing (108) comprises an authentification interface which allows a user to input authentification data being necessary for providing the missing cryptographic key.

11. Network according to claim 10, wherein the authenfication data is specific to the new node (106).

12. Network according to claim 1, wherein the new node (106) is capable of calculating different cryptographic keys each being characterized by a key index, and wherein the new node is configured to provide a key index characterising the associated key to the first node (102) and wherein the first node is configured to request the cryptographic key characterized by the key index after having received the key index.

13. Network according to claim 1, wherein the network is a wireless sensor network and the new node (106) is a sensor of the wireless sensor network.

14. Trust center suitable for a network security initialization, comprising:
means for detecting a presence of a new node in the network, wherein the new node comprises an cryptographic key;
means for requesting the cryptographic key; and
means for receiving a missing cryptographic key from a device different to the new node, wherein the missing cryptographic key is equal to the cryptographic key.

15. Method for initializing a network key, comprising the steps of:
specifying (422) a cryptographic key by a new node of a network, based on a node specific cryptographic keying material;
requesting (424) the cryptographic key by a first node of the network;
providing (426) a missing cryptographic key to the first node from a storage different to the new node, wherein the missing cryptographic key is equal to the cryptographic key.

16-17. (canceled)
